(19) United States
(12) Patent Application Publication
(10) Pub. No.: US 2011/0049348 A1
(43) Pub. Date: Mar. 3, 2011

(54) MULTIPLE INLET ATMOSPHERIC PRESSURE IONIZATION APPARATUS AND RELATED METHODS

(76) Inventor: Gregory J. Wells, Fairfield, CA (US)

(21) Appl. No.: 12/547,400

(22) Filed: Aug. 25, 2009

(51) Int. Cl. H01J 49/10

(52) U.S. Cl. 250/282; 250/288; 250/285

(57) ABSTRACT

An atmospheric pressure ionization apparatus with a plurality of sprayers configured for producing separate gas streams comprising charged material, an interface structure, and a capillary. The interface structure includes a plurality of entrance orifices aligned on-axis or off-axis with respective sprayers, a plurality of desolvating passages extending from the entrance orifices to respective passage outlets, and a common passage communicating with the passage outlets. The desolvating passages form a plurality of input flow paths running from the entrance orifices and merging into the common passage. The capillary communicates with the common passage and extends therefrom to a capillary outlet positioned outside the interface structure, wherein the capillary forms a single output flow path running from the merged input flow paths to the capillary outlet. Desolvated ions from the first and second passages may be flowed together through the capillary as a mixture, or may be flowed sequentially.

### FIELD OF THE INVENTION

The present invention relates generally to the ionization of molecules which finds use, for example, in fields of analytical chemistry such as mass spectrometry. More particularly, the present invention relates to producing a single ion beam from more than one atmospheric-pressure ionizing (API) device. The single ion beam may be outputted, for example, to an analyzing instrument.

### BACKGROUND OF THE INVENTION

Mass spectrometry (MS) systems enable sample materials to be resolved according to their mass-to-charge (m/z) ratios. The theory, design and operation of various types of mass spectrometers and their constituent components are well-known to persons skilled in the art and thus need not be detailed in the present disclosure. As a brief summary, a mass spectrometer typically includes a sample introduction system, an ionizing device, one or more mass analyzers, and circuitry for ion and electrical signal processing, data acquisition, and readout/display. The sample introduction system typically operates at or around atmospheric pressure and may involve the use of an analytical separation device such as a chromatography device. The ionizing device receives the sample, ionizes it, and transmits it to the mass analyzer. Various types of ionizing devices are commercially available and differ in their mechanisms for ionization. Ionizing devices may also be classified according to whether they operate in vacuum or at or near atmospheric pressure. Atmospheric-pressure ionizing (API) devices are advantageous because they provide an interface between the ambient or pressurized environment in which the sample originates and the vacuum environment in which mass analyzers and their associated ion detectors operate effectively. The mass analyzer receives an ion stream from the ionizing device and, depending on its design, utilizes electric and/or magnetic fields to confine the ions and separate them in space or time based on their m/z ratios. The resulting mass-resolved ion output is transmitted to an ion detector for conversion to an electrical output, which is further processed to produce a mass spectrum, typically a series of signal peaks indicative of the relative abundances of the detected ion masses.

FIG. 1 is a schematic view of an example of an MS system 100 according to known design. The MS system 100 generally includes an API apparatus 104 of the type often referred to as a “nozzle beam” interface, and a mass analyzer 108 and associated components (e.g., ion detector, electronics, not specifically shown). The API apparatus 104 includes an ionizing device such as an electrospray ionizing (ESI) device 112 with a capillary or electrospray needle 116, followed by an interface capillary 120 mounted at a suitable structure 124. The structure 124 may include a heating device 128 positioned so as to be in thermal contact with the interface capillary 120. The interface capillary 120 extends into a sealed vacuum chamber 132 in which the mass analyzer 108 is located. The vacuum chamber 132 may include one or more subchambers or pump stages 134, 136 for successively reducing pressure down to the vacuum level required by the mass analyzer, using vacuum pumps 138, 140. A skimmer cone 144 with a hole 148 at its tip serves as the interface between the interface capillary 120 and the mass analyzer 108. In operation, a liquid sample is flowed through the ionizer's capillary 116. The liquid sample is often provided in the form of a matrix consisting not only of the molecules to be investigated (analytes) but also one or more solvents and possibly other non-analytical components. In the case of ESI, as the sample flows though the capillary 116, a voltage potential is applied between the capillary 116 and an appropriately positioned counter-electrode, such as a surface of the structure 124, a plate surrounding the inlet to the interface capillary 120, etc. The electric field established by this voltage potential induces charge accumulation at the surface of the liquid at the tip of the capillary 116, and the liquid is discharged from the capillary 116 as a spray of charged droplets, or electrospray 152. The ESI device 112 may provide a gas flow or other means for assisting in the nebulization of the liquid. The electrospray 152 is directed toward the entrance of the interface capillary 120 (often termed a sampling orifice), which may be assisted by the electric field. The electrospray droplets flow through the interface capillary 120 under the influence of the pressure differential between the API apparatus 104 and the low-pressure and vacuum stages of the chamber 132. The internal diameter of the interface capillary 120 is small enough to maintain this pressure differential. As the electrospray droplets flow through the interface capillary 120 they undergo a desolvation (or ion evaporation) process. As the solvent contained in the droplets evaporates the droplets become smaller, they may rupture and divide into even smaller droplets as a result of repelling coulombic forces approaching the cohesion forces of the droplets. The heater 128 is provided to assist in the evaporation. Eventually, analyte ions desorb from the surfaces of the droplets. Consequently, a gaseous, ion-enriched stream enters the mass analyzer 108 via the skimmer cone 144. Excess gas from the interface capillary 120 is removed by the vacuum pump 138.

FIG. 2 is a schematic view of a gas/ion stream exiting from an interface capillary 220 of known design and entering a hole 248 of a skimmer cone 244 along a common axis 256. From the perspective of fluid mechanics, the outlet of the interface capillary 220 operates as an expansion nozzle. Ions and neutral gaseous components exit the interface capillary 220 in the form of an expanded beam 260. Gas expanding from the outlet of the interface capillary 220 forms a series of shock waves, including a barrel shock 262 and a Mach disk 264. The barrel shock 262 and Mach disk 264 are regions of high gas density. The barrel shock 262 coaxially surrounds a silent zone 266. The silent zone 266 is a region of low gas density and is typically lower in density than the region outside the barrel shock 262. Ions having masses larger than the gas molecules remain focused along the axis 256. Hence, there is an enrichment of ions relative to the neutral gas in the region around the axis 256. Ideally, only the analyte ions and not neutral gas components enter the mass analyzer 108 (FIG. 1). Thus, it is advantageous to position the skimmer cone 244 such that the hole 248 at its tip is aligned with the axis 256 of the outlet of the interface capillary 220, and at a distance from the capillary outlet such that the skimmer cone tip penetrates through the Mach disk 264 into the silent zone 266 (and thus the hole 248 is positioned in the silent zone 266), as illustrated in FIG. 2. This configuration ensures that the ion stream enters the housing 132 of the mass analyzer 108 in an optimized manner, with neutral gas molecules and other unwanted components deflected away by the skimmer cone 244.

Mass spectrometers capable of high resolution and accurate mass measurements can have their mass accuracy improved by measuring the mass of a known reference molecule simultaneously with the mass of a sample molecule. Alternatively, the ions from the sample and reference molecules can be measured sequentially in close time proximity. The purpose of a reference measurement is to compensate for the time-dependent drift of the mass position due to changes in the characteristics of the mass spectrometer such as electronic drift, temperature changes, etc., as well as space-charge induced mass shifts found in ion trapping devices in which the charge of other ions in the trap alter the electric field environment for the ion of interest. To provide both sample and reference ions, it is known to use multiple electrospray assemblies directed toward a common inlet aperture into a vacuum chamber. The disadvantage of this approach is that the droplets from the two separate sprays can merge in the region proximate to, and downstream from, the exits of the spray capillaries. This can cause ion suppression in the liquid phase prior to entering the API interface (i.e., prior to the desolvation process). Ion suppression occurs when two different types of molecules in the liquid droplet compete for the available charge. When this occurs, molecules with lower proton affinity than other molecules in the liquid will not be efficiently charged by proton attachment. Another approach utilizes mechanical means to alternately translate separate electrospray ion sources into alignment with the inlet to a mass spectrometer. The disadvantage of this approach is the slow response time of the mechanism when switching between different sprayers and the inherently poor reliability of moving mechanisms. In another approach, the electrosprays from separate spray sources are alternately turned on and off. This approach requires a lengthy response time and stabilization period for a spray to become stable; typically several seconds are required. Other known approaches to employing multiple API sources are not designed so as to produce the advantageous gas/ion discharge regime illustrated in FIG. 2, i.e., production of a supersonic expansion 260 with shock structures 262, 264 and in which the silent zone 266 is sampled by a skimmer cone 244 axially aligned with the interface capillary 220.

Accordingly, there is a need for improved apparatus and methods for sampling ions formed from two or more different ion sources. There is also a need for apparatus and methods capable of controllably combining two or more ionizing streams into a single stream for discharge from the exit of a capillary and into a desired destination, such as a skimmer cone or other interface to a mass analyzer or other ion-processing instrument. There is also a need for apparatus and methods for independently controlling the flow of ions from each of the separate ionization sources into a common interface capillary.

### SUMMARY OF THE INVENTION

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one implementation, an atmospheric pressure ionization (API) apparatus includes a plurality of API sprayers configured for producing separate gas streams of charged material, an interface structure, and a capillary. The interface structure includes a plurality of entrance orifices aligned in flow communication with respective API sprayers at distances therefrom, a plurality of desolvating passages extending though the interface structure from the respective entrance orifices to respective passage outlets, and a common passage communicating with the passage outlets. The desolvating passages form a plurality of respective input flow paths running from the respective entrance orifices and merging into the common passage. The capillary communicates with the common passage and extends therefrom to a capillary outlet positioned outside the interface structure, wherein the capillary forms a single output flow path running from the merged input flow paths to the capillary outlet.

According to another implementation, a method is provided for producing a single ion beam from a plurality of available atmospheric pressure ionization (API) sources. A first stream including charged droplets produced by a first API sprayer is flowed through a first passage to desolvate the droplets and produce a first stream including first ions. A second stream including charged droplets produced by a second API sprayer is flowed through a second passage to desolvate the droplets and produce a second stream including second ions. The first ions are flowed from the first passage into a capillary at or near atmospheric pressure, through the capillary and into a sub-atmospheric pressure chamber of lower pressure than the first passage and the second passage. The second ions are flowed from the second passage into the capillary at or near atmospheric pressure, through the capillary and into the sub-atmospheric pressure chamber. The first ions and the second ions may be flowed together through the capillary as a mixture, or may be flowed sequentially.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a mass spectrometry (MS) system according to known design.

FIG. 2 is a schematic view of an ion stream exiting from an interface capillary of known design and entering a skimmer cone along a common axis

FIG. 3 is a schematic view of an example of an API apparatus provided in accordance with the present disclosure.

FIG. 4 is a schematic view of another example of an API apparatus provided in accordance with the present disclosure.

FIG. 5 is an elevation view of an example of an electrostatic lens that may be utilized in an API apparatus in accordance with the present disclosure.

FIG. 6 is an elevation view of an inlet side of an API structure according to another implementation.

FIG. 7 is an elevation view of an inlet side of an API structure according to another implementation.

### DETAILED DESCRIPTION OF THE INVENTION

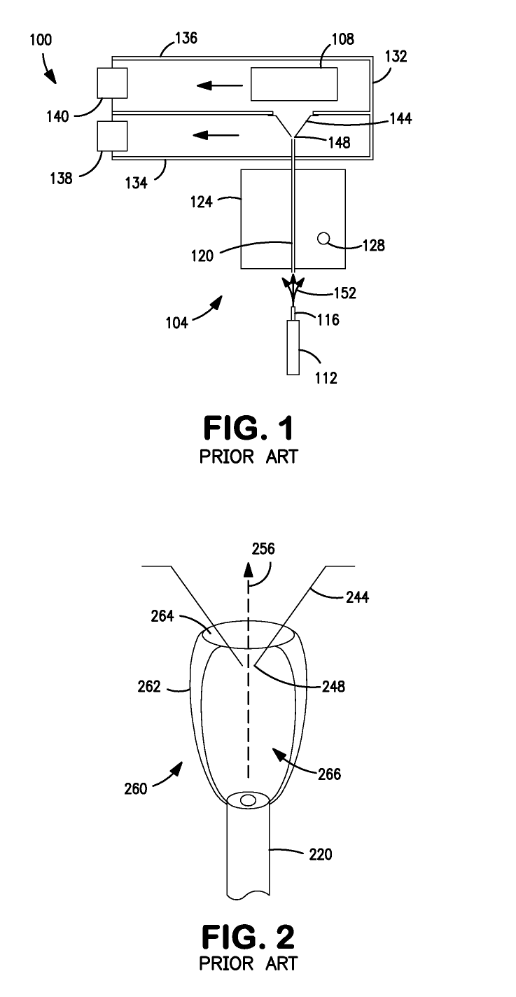

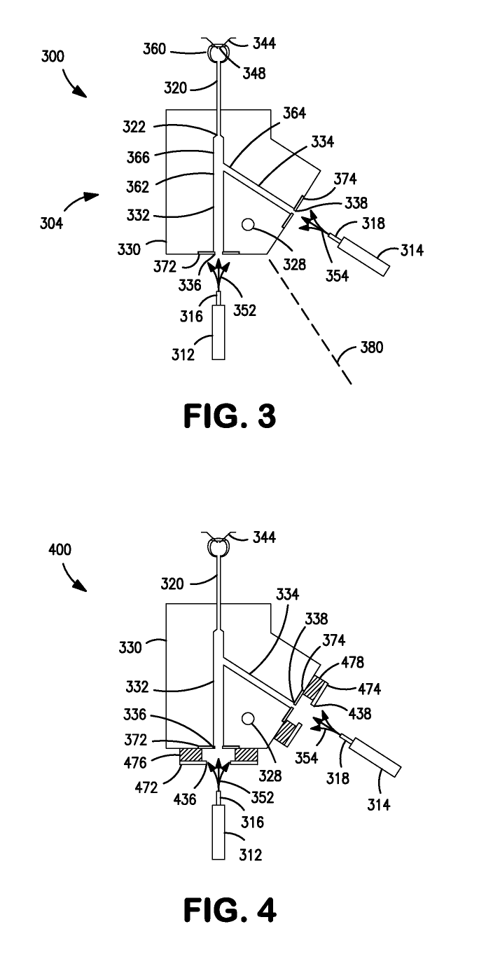

The subject matter disclosed herein generally relates to the ionization of molecules, in which a single ion beam is produced from more than one atmospheric-pressure ionizing (API) device for output to a desired destination such as an analyzing instrument. Examples of implementations of methods and related devices, apparatus, and/or systems are described in more detail below with reference to FIGS. 3-7. These examples may be implemented in conjunction with the subject matter described above and illustrated in FIGS. 1 and 2. These examples are described at least in part in the context of mass spectrometry (MS). However, any process that involves the ionization of molecules may fall within the scope of this disclosure.

FIG. 3 is a schematic view of an example of an API apparatus 300 provided in accordance with the present disclosure. The API apparatus 300 includes a plurality of separate API spray devices 312, 314, an API interface 304, and an interface capillary 320. The interface capillary 320 extends from an inlet 322 located within the API interface 304 to an outlet 324 outside the API interface 304. In operation, an ion-containing gas stream may be discharged from the interface capillary outlet 324 in the form of an expanded beam 360 characterized by a silent zone bounded by shock structures as described above in conjunction with FIG. 2. In advantageous implementations, the interface capillary 320 is oriented along a common axis with a skimmer cone 344 and at a distance therefrom such that the tip (and corresponding hole 348) of the skimmer cone 344 extends into the silent zone of the capillary discharge, whereby ions are efficiently sampled by the skimmer cone 344. The skimmer cone 344 may serve as the interface to a mass analyzer as described above in conjunction with FIG. 1. For simplicity, only two API spray devices 312, 314 are illustrated with the understanding that more than two may be provided. Each spray device 312, 314 may be connected to a separate liquid source (not shown), which may be the output of an analytical separation device or other source of molecules as noted earlier. Each spray device 312, 314 may include a capillary 316, 318 from which a droplet spray (or stream) 352, 354 is discharged. Depending on design, the spray devices 312, 314 may include nebulizing-assist components and vaporizing components (not shown). The spray devices 312, 314 may be configured as, for example, ESI devices in which case the droplet sprays 352, 354 may be referred to as electrosprays. In a typical implementation, the droplet sprays 352, 354 include a combination of ions, ion clusters, charged droplets, and neutral droplets. In the present example, the first spray device 312 produces a sample droplet spray 352 derived from analyte molecules to be investigated, and the second spray device 314 produces a reference droplet spray 354 derived from molecules of a reference compound of known properties. A reference compound is useful, for example, as an internal mass standard when analyzing a sample in accordance with mass spectrometry. Alternatively, the second spray device 314 may be utilized to ionize another analytical sample having a composition different from that processed by the first spray device 312, or one or more additional spray devices (not shown) may be utilized to ionize different analytical samples.

The API interface 304 is configured to desolvate the respective droplet sprays 352, 354 separately and independently of each other, and subsequently merge the resulting ion streams into a single ion stream which then enters the interface capillary 320. By desolvating the individual droplet sprays 352, 354 prior to ion transmission into the interface capillary 320, ion suppression is avoided. To process separate droplet sprays 352, 354 independently, the API interface 304 includes a structure 330 through which a first passage 332 and a second passage 334 extend from respective entrance orifices 336, 338. The first passage 332 and the second passage 334 may be any type of conduits suitable for providing separate flow paths for the droplet sprays 352, 354. Thus, for example, the first passage 332 and the second passage 334 may be provided in the form of tubes supported in the structure 330, or bores formed through a solid portion of the structure 330. The first passage 332 and the second passage 334 have lengths sufficient for desolvation to be completed for the gas flow rates contemplated. While two passages 332, 334 are illustrated in the example of FIG. 3, it will be understood that additional passages (not shown) may be included in accordance with a desired number of individual droplet sprays 352, 354 to be processed. To assist in desolvation, a heating device 328 may be mounted at (in, on, etc.) the structure 330 so as to be in thermal contact with the first passage 312 and the second passage 314, i.e., at a position relative to the first passage 312 and the second passage 314 suitable for efficiently conducting heat to the first passage 312 and the second passage 314. In one implementation, the structure 330 is a predominantly solid heater block and the heating device 328 is an electrically resistive heating device that transmits heat to the first passage 312 and the second passage 314 primarily by conduction. In another implementation, heating device 328 may be configured to circulate a heat transfer fluid into thermal contact with the first passage 312 and the second passage 314 whereby heat is transferred by convection as well as conduction modes.

The first passage 312 and the second passage 314 have respective passage inlets corresponding to the first entrance orifice 336 and the second entrance orifice 338. The first entrance orifice 336 and the second entrance orifice 338 may be formed separately and positioned adjacent to the passage inlets, as described below. The first passage 332 and the second passage 334 extend from their respective passage inlets to respective passage outlets 362, 364 over a distance sufficient for effective desorption to occur and for sufficient heat transfer to occur to assist in desorption. In a typical implementation, the first passage 332 and the second passage 334 are straight sections of conduits to facilitate gas flow and desorption. The passage outlets 362, 364 are in flow communication with a common passage 366 (or chamber, etc.) which in turn is in flow communication with the interface capillary 320. As noted previously, the interface capillary 320 is a small-bore conduit sized to effectively transmit an ion stream while maintaining a pressure differential between the atmospheric or near-atmospheric environment of the API interface 304 and the reduced-pressure or vacuum environment at the discharge side of the interface capillary 320. It can be seen that ions from different sources may be mixed in the common passage 366 at atmospheric or near-atmospheric pressure. In this pressure range the ion mean-free path is short and interaction between different ions is minimal. In a typical implementation, this pressure range is from about 100 mTorr to (and including) atmospheric pressure (760 Torr).

In a typical implementation, the internal diameters of the first passage 332, the second passage 334 and the common passage 366 are greater than the internal diameter of the interface capillary 320 and the diameters of the entrance orifices 336, 338. The internal diameters of the first passage 332 and the second passage 334 may be relatively large for ease of fabrication and to provide a large surface area to effect desolvation of the droplets as they pass through. The linear velocity of the gas flows are reduced as the gases traverse the larger-diameter passages, thereby increasing the residence time for desolvation. The respective internal diameters of the first passage 332, the second passage 334 and the common passage 366 may be equal or substantially equal to each other, or may be different from each other. More generally, the first passage 332 and the second passage 334 establish a first fluid flow path and a second fluid flow path, respectively, that merge or combine into a common fluid flow path in the common passage 366, and the common fluid flow path enters, runs through and exits from the interface capillary 320. For this purpose, the first passage 332 and the second passage 334 (and any additional passages provided for desorption of additional droplet sprays) are oriented at angles to each other, a typical angle being less than ninety degrees and preferably much less (e.g., 45 degrees or less) to promote efficient gas flow to the interface capillary 320.

In operation, the separate droplet streams may be flowed through the first passage 332 and the second passage 334 simultaneously or sequentially. Accordingly, in the case of simultaneous flows the common passage 366 is configured to receive the flow of ion-containing gas from the first passage 332 and the flow of ion-containing gas from the second passage 334, allow the components of the flows to mix together, and transmit a single flow of mixed components into the interface capillary 320. In the case of sequential flows, the common passage 366 serves to receive the flow of ion-containing gas from any selected passage 332, 334 and efficiently transmit that flow into the interface capillary 320 regardless of the orientation of the selected passage 332, 334 relative to the common passage 366 and to other passages. For these purposes, the common passage 366 may have any suitable configuration (e.g., internal diameter, length, shape, etc.). For these purposes, and depending on the design and fabrication of the API interface 304, the common passage 366 may characterized as a third passage distinct from the first passage 332, the second passage 334 and the interface capillary 320, or as an extension of one passage 332 or 334 with which the outlet of another passage 334 or 332 communicates, or as a larger-diameter entrance section of the interface capillary 320, etc. In all such cases, the API interface 304 is configured such that by time sample material and/or reference material reaches the entrance 322 to the interface capillary 320, most or all of the liquid-phase components have evaporated and the clustered and solvated ions have been liberated, all of which occurs prior to mixing in the case of simultaneous flows through the passages 332, 334. Consequently, this configuration enables acquisition of a higher ion signal, lower chemical background, higher signal-to-noise (S/N) ratio, higher sensitivity, and less contamination of the downstream MS instrument. For efficient transfer of gas flow(s) into the interface capillary 320, the outlet of the common passage 366 and the inlet 322 of the interface capillary 320 should be aligned along a common axis. It is also advantageous for the axis of at least one passage 332, particularly a passage utilized for sample ions, to be aligned with the axis of the common passage 366 and the interface capillary 320 to optimize flow efficiency in that passage 332.

The entrance orifices 336, 338 are associated with corresponding ion spray entrances into the first passage 332 and the second passage 334. The respective entrance orifices 336, 338 may be formed through separate orifice plates 372, 374 mounted to outer faces of the API structure 330. The orifice plates 372, 374 may be removable and replaceable. The orifice plates 372, 374 may be composed of a metal or other conductive material. Optionally, DC voltage sources (not shown) may be connected to the orifice plates 372, 374 whereby the orifice plates 372, 374 operate as counter-electrodes to assist in guiding the droplet sprays 352, 354 into the respective entrance orifices 336, 338. In a typical implementation, the diameters of the entrance orifices 336, 338 are smaller than the corresponding internal diameters of the first passage 332 and the second passage 334. In some implementations, the diameter of at least one entrance orifice 336, 338 may differ from the diameter of the other entrance orifices 336, 338 to enable control over the relative gas flow through the respective entrance orifices 336, 338. For example, the diameter D1 of the first entrance orifice 336 may be greater than the diameter D2 of the second entrance orifice 338. The difference in diameters D1 and D2 may be such that most of the gas flows are into the first entrance orifice 336 and not the second entrance orifice 338. This may be desired in the case where the first API device 312 is utilized to ionize the sample of interest and the second API device 314 is utilized to ionize the reference compound. The liquid flow rate and concentration of the reference compound provided to the API device 314 may be selected to provide a stable flux of reference ions suitable for an internal mass standard. The liquid flow rate and concentration of the sample compound will vary depending on the application. With a large-diameter first entrance orifice 336, the efficiency of transporting sample ions of the first droplet spray 352 into the first entrance orifice 336 is very high. A large diameter D1 for the first entrance orifice 336 is also desirable because the sample droplet spray 352 is often accompanied by undesired background matrix material that may plug the first entrance orifice 336 if its diameter D1 is too small. Meanwhile, the lower gas flow into the second entrance orifice 338, due to a smaller diameter D2, may be compensated for by using a larger concentration of reference compound. With a small diameter D2 for the second entrance orifice 338, plugging is not a concern as only clean reference compound flows through the second entrance orifice 338. When orifice plates 372, 374 are provided, the diameters D1 and D2 may be easily changed by replacing the orifice plates 372, 374 with other ones having different sized entrance orifices 336, 338. As also illustrated in FIG. 3, a structural partition 380 may be provided between adjacent API devices 312, 314 to ensure separation of the individual droplet flows 352, 354 so as to prevent them from mixing prior to admission into the API structure 330, particularly in the case of high droplet spray flow rates.

FIG. 4 is a schematic view of an example of an API apparatus 400 provided in accordance with another implementation. In this implementation, respective electrostatic lenses 472, 474 with apertures 436, 438 are located in front of the first entrance orifice 336 and the second entrance orifice 338 and electrically isolated from the API structure 330 or orifice plates 372, 374 by respective insulators 476, 478. Each lens 472, 474 may be connected to a DC voltage source (not shown). In this manner, the lenses 472, 474 may be utilized to improve the transport of droplets from the API device capillaries 316, 318 into the corresponding entrance orifices 336, 338 by providing electric fields such that ions are attracted toward the lenses 472, 474 and then focused into the entrance orifices 336, 338. Lenses 472, 474 of this type are often referred to as “spray shields” because they additionally serve to shield the entrance orifices 336, 338 from excess liquid and large droplets that flow from the API device capillaries 316, 318. Excess liquid and large droplets often have low charge abundance and are difficult to desolvate, and will contribute to contamination of the entrance orifices 336, 338.

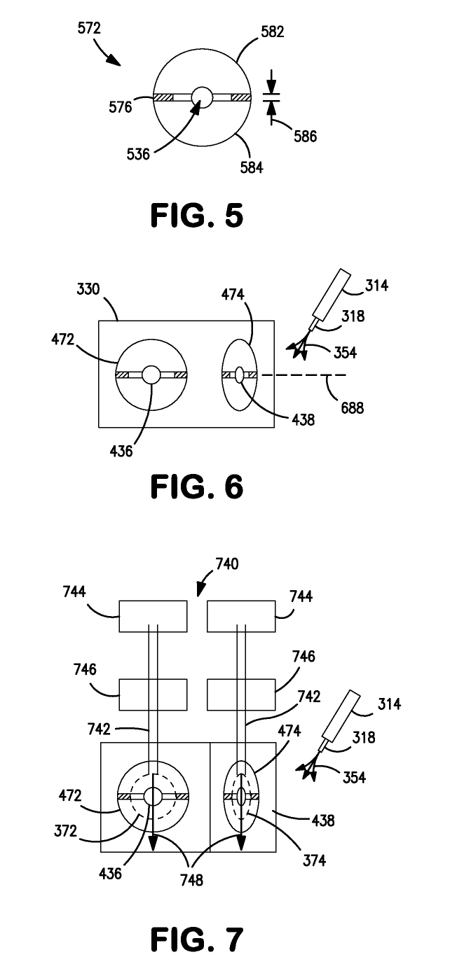

FIG. 5 is an elevation view of another example of an electrostatic lens 572 that may be utilized in any API apparatus disclosed herein. With very high-resolution instruments such as, for example, FTMS it is generally sufficient to have both sample and reference ions in the same spectrum, i.e., simultaneously flow and create a mixture of sample ions and reference ions to provide an internal mass standard and readily distinguishable sample peaks and reference peaks. However, there are cases in which the unknown sample molecules and reference molecules produce ion masses that are nearly the same and therefore overlap and prevent an accurate mass measurement of each ion mass due to a shift of the mass centroid or the large difference in abundance of one of the ion species. In this situation it is preferable to make a sequential mass measurement in which the sample ions are measured first followed by measurement of the reference ions only. The electrostatic lens 572 illustrated in FIG. 5 is an example of one way to control the respective flows of sample ions and reference ions for this purpose. As described above, the lens 572 is based on an electrically conductive element mounted to an insulator 576 and having an aperture 536 formed around the axis through which the droplet spray passes. However, the conductive element in the present example is essentially split into two halves, i.e., comprises a first section 582 and a second section 584 separated by a gap 586 perpendicular to the lens axis. The first section 582 and the second section 584 are independently energizable by DC sources (not shown) for applying an electric field across this gap 586 and thus across the lens aperture 536. When each section 582, 584 is at the same voltage potential, ions will be focused into the aperture 536 and the subsequent entrance orifice of the API interface. When the sections 582, 584 are at large voltages of opposite polarity, ions will be deflected and will not pass through the aperture 536. A split-configuration lens 572 may be mounted in front of the first entrance orifice 336 and the second entrance orifice 338 (FIG. 4). Therefore, this type of lens 572 may be utilized to control whether sample droplets 352 or reference droplets 354 enter the respective entrance orifices 336, 338 at any given time, and thus control which flow paths in the respective flow passages 332, 334 are active, and in turn control which type of ions enter the interface capillary 320 and subsequent vacuum chamber for analysis. As an alternative to operating essentially as an ON/OFF gate, the voltages applied to the first section 582 and the second section 584 can be varied such that the lens 572 operates essentially as a metering valve. That is, the degree of deflection caused by the electric field across the gap 586 may be adjusted by adjusting the voltages applied to the sections 582, 584, thus enabling the user to proportion or select the efficiency of a given flow through the aperture 536 of the lens 572. The use of the split lens 572 does not require turning the API device 312, 314 ON or OFF or mechanically translating the API device 312, 314, and thus preserves the stability of the operation of the API device 312, 314 and ensuing droplet flow 352, 354 and does not raise concerns of reliability.

An example of sequential-flow mode of operation will now be described with reference to FIG. 4, in which the electrostatic lenses 472, 474 have a split configuration such as illustrated in FIG. 5. During a first time period P1, the sample ions (entrained in the droplets of the first stream 352) are admitted into the first entrance orifice 336, while the reference ions (entrained in the droplets of the second stream 354) are deflected by the second lens 474 in the manner described above and hence prevented from entering the second entrance orifice 338. The sample ions then pass through the first passage 332 where they evaporate from the droplet material (which may be assisted by heating as described above). The sample ions then pass through the interface capillary 320 and are transported into the mass analyzer via the skimmer cone 344 for mass analysis to produce a first mass spectrum of the sample. During a second time period P2, the sample ions are deflected by the first lens 472 and hence prevented from entering the first entrance orifice 336, while the reference ions are admitted into the second entrance orifice 338. This switching of flows is done by changing the DC voltages applied to the sections 582, 584 of the first lens 472 and the second lens 474 in the manner described above in conjunction with FIG. 5. The reference ions are then desolvated in the second passage 334 and transported through the interface capillary 320, skimmer cone 344 and mass analyzer for mass analysis to produce a second mass spectrum of the reference molecule. Since the two spectra (sample and reference) are measured in close proximity of time the effects of electronic drift and temperature changes are negligible. Moreover, the respective sample and reference masses are measured separately and therefore even if the sample and reference ions are very close in mass or of significantly different abundances, they can still be accurately measured. Because the exact mass of the reference molecule is known, the mass of the sample molecule can be accurately determined by calibration means known in the art.

FIG. 6 is an elevation view of an inlet side of the API structure 330 according to another implementation. FIG. 6 illustrates the two electrostatic lenses 472, 474 mounted in front of respective entrance orifices with their respective apertures 436, 438 aligned with the entrance orifices, and an axis 688 about which the second entrance orifice (and lens aperture 438) is oriented. The lenses 472, 474 may have the split configuration described above in conjunction with FIG. 5. For simplicity, only a single API spray device 314 is illustrated, aimed at the second entrance orifice. In the previous examples described above, the outlets of the API spray devices 312, 314 are collocated on the same axis as the entrance orifices. As shown in FIG. 6, however, any spray device 312, 314 may be oriented off-axis (at an angle) relative to its corresponding entrance orifice. In many applications, the off-axis arrangement is preferred for flow rates in the microliter/minute range and above because it prevents large droplets of low charge from entering the entrance orifice and contaminating it. The off-axis arrangement may be useful for sample sprays and/or reference sprays. On the other hand, a sample spray is often operated at flow rates below one microliter/minute (e.g., nanospray applications). In this latter, low range of flow rates, it is often preferable to locate the outlet of the spray device on the same axis as the entrance orifice.

FIG. 7 is an elevation view of an inlet side of the API structure 330 according to another implementation. FIG. 7 illustrates two electrostatic lenses 472, 474 in front of respective entrance orifices, which are formed through respective orifice plates 372, 374 in this example. The lenses 472, 474 may have the split configuration described above in conjunction with FIG. 5. For simplicity, only a single API spray device 314 is illustrated, aimed at the second entrance orifice in an off-axis orientation in this example. In this implementation, the API apparatus includes a drying gas flow device 740 configured to establish a flow of heated drying gas (e.g., nitrogen) through the space between any or all corresponding pairs of entrance orifices and electrostatic lenses 472, 474, whereby the drying gas intersects the axis of the entrance orifice(s) and thus the flow of sprayed droplets 352, 354 (FIG. 4) from the spray device(s) 312, 314. In this manner, the drying gas assists in desolvating the charged droplets and deflecting the uncharged droplets away from the entrance orifice(s). The drying gas flow device 740 may have any configuration suitable for this purpose. By way of example, FIG. 7 illustrates drying gas conduits 742 extending into the space behind respective electrostatic lenses 472, 474 and communicating with respective gas flow controllers 744 and gas heaters 746. In operation, the drying gas delivery device 740 establishes one or more flows 748 of heated drying gas directed so as to intersect one or more selected droplet streams 352, 354 in front of the corresponding entrance orifices. Additionally or alternatively, a combination of increased drying gas flow and deflecting voltages on the lenses 472, 474 may be utilized to prevent uncharged droplets as well as ions from approaching the entrance orifice(s) and thereby prevent contamination of the entrance orifice(s) during time periods when ion sampling is not desired.

It will be understood that the methods and apparatus described in the present disclosure may be implemented in an ion processing system such as an MS system as generally described above by way of example. The present subject matter, however, is not limited to the specific ion processing systems illustrated herein or to the specific arrangement of circuitry and components illustrated herein. Moreover, the present subject matter is not limited to MS-based applications, as previously noted.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation-the invention being defined by the claims.

What is claimed is:

1. An atmospheric pressure ionization (API) apparatus, comprising:
a plurality of API sprayers configured for producing separate gas streams comprising charged material;
an interface structure comprising a plurality of entrance orifices aligned in flow communication with respective API sprayers at distances therefrom, a plurality of desolvating passages extending though the interface structure from the respective entrance orifices to respective passage outlets, and a common passage communicating with the passage outlets, wherein the desolvating passages form a plurality of respective input flow paths running from the respective entrance orifices and merging into the common passage; and
a capillary communicating with the common passage and extending therefrom to a capillary outlet positioned outside the interface structure, wherein the capillary forms a single output flow path running from the merged input flow paths to the capillary outlet.

2. The API apparatus of claim 1, further comprising a heating device positioned at the interface structure for heating the plurality of desolvating passages.

3. The API apparatus of claim 1, wherein the entrance orifices have respective entrance orifice diameters and the desolvating passages have respective internal diameters greater than the corresponding entrance orifice diameters, and the capillary has an internal diameter less than an internal diameter of the common passage.

4. The API apparatus of claim 1, wherein the entrance orifices comprise a first entrance orifice having a first diameter and a second entrance orifice having a second diameter less than the first diameter.

5. The API apparatus of claim 4, wherein the API sprayer communicating with the first entrance orifice is configured for spraying a droplet stream comprising a sample material and the API sprayer communicating with the second entrance orifice is configured for spraying a droplet stream comprising a reference material.

6. The API apparatus of claim 1, further comprising an orifice plate through which at least one of the entrance orifices is formed, the orifice plate being removable from the interface structure.

7. The API apparatus of claim 1, wherein at least one of the desolvating passages is axially aligned with an inlet of the capillary.

8. The API apparatus of claim 1, further comprising a skimmer cone axially aligned with the capillary outlet and interposed between the capillary outlet and a sub-atmospheric pressure chamber.

9. The API apparatus of claim 1, further comprising a plurality of electrostatic lenses interposed between respective entrance orifices and API sprayers, each lens having a lens aperture disposed about a lens axis aligned with a respective entrance orifice.

10. The API apparatus of claim 9, wherein each lens comprises a first section and a second section separated from the first section by a gap perpendicular to the lens axis, and the first section and the second section are independently energizable for applying an electric field across the gap.

11. The API apparatus of claim 1, wherein each API sprayer comprises a sprayer outlet disposed about a respective sprayer outlet axis, each entrance orifice is disposed about a respective entrance orifice axis, and the API sprayers are oriented in a position selected from the group consisting of: at least one sprayer outlet axis being inline with the corresponding entrance orifice axis, and at least one sprayer outlet axis being at an angle to the corresponding entrance orifice axis.

12. The API of claim 1, further comprising a plurality of electrostatic lenses interposed between respective entrance orifices and API sprayers, each lens having a lens aperture disposed about a lens axis aligned with a respective entrance orifice, and a gas delivery device configured for flowing one or more gas streams between respective entrance orifices and lenses in a direction intersecting the respective lens axes.

13. A method for producing a single ion beam from a plurality of available atmospheric pressure ionization (API) sources, the method comprising:
flowing a first stream comprising charged droplets produced by a first API sprayer through a first passage to desolvate the droplets and produce a first stream comprising first ions;
flowing a second stream comprising charged droplets produced by a second API sprayer through a second passage to desolvate the droplets and produce a second stream comprising second ions;
flowing the first ions from the first passage into a capillary at or near atmospheric pressure, through the capillary and into a sub-atmospheric pressure chamber of lower pressure than the first passage and the second passage; and
flowing the second ions from the second passage into the capillary at or near atmospheric pressure, through the capillary and into the sub-atmospheric pressure chamber.

14. The method of claim 13, further comprising heating the first droplet stream as it flows through the first passage and heating the second droplet stream as it flows through the second passage.

15. The method of claim 15, wherein:
flowing the first ions and the second ions through the capillary further comprises discharging an expanded beam from a capillary outlet, the expanded beam comprising an ion-enriched silent zone coaxial with an axis of the capillary outlet and bounded by shock structures, wherein the expanded beam has an ion composition selected from the group consisting of: a mixture of first ions and second ions, and first ions sequentially followed by second ions; and
flowing the first ions and the second ions into the sub-atmospheric pressure chamber comprises flowing the ions in the silent zone through a hole of a skimmer cone interposed between the capillary outlet and the sub-atmospheric pressure chamber, wherein the hole is aligned with capillary outlet axis and positioned at an axial distance from the capillary outlet such that the skimmer cone penetrates the shock boundaries and the hole is disposed in the silent zone.

16. The method of claim 13, further comprising flowing the first droplet stream into the first passage via a first entrance orifice, flowing the second droplet stream into the second passage via a second entrance orifice, and proportioning respective flow rates of the first droplet stream and the second droplet stream by selecting different respective diameters for the first entrance orifice and the second entrance orifice.

17. The method of claim 13, further comprising mixing the first ions and the second ions together by flowing the first droplet stream and the second droplet stream simultaneously through the respective first passage and the second passage and into a common passage preceding the capillary, wherein flowing the first ions and the second ions through the capillary comprises flowing a mixture of the first ions and the second ions through the capillary as a single ion stream.

18. The method of claim 13 further comprising controlling the respective flows of the first droplet stream and the second droplet stream by performing a step selected from the group consisting of:
(a) while flowing the first droplet stream through the first passage, preventing the second droplet stream from flowing through the second passage and, while flowing the second droplet stream through the second passage, preventing the first droplet stream from flowing through the first passage, wherein flowing the first ions through the capillary and flowing the second ions through the capillary occur sequentially; and
(b) proportioning the respective flows of the first droplet stream and the second droplet stream according to a desired proportion.

19. The method of claim 18, wherein preventing the first droplet stream from flowing comprises applying a voltage to a first lens positioned in front of the first passage sufficient to deflect the first droplet stream away from the first passage, and preventing the second droplet stream from flowing comprises applying a voltage to a second lens positioned in front of the second passage sufficient to deflect the second droplet stream away from the second passage.

20. The method of claim 18, wherein proportioning the respective flows of the first droplet stream and the second droplet stream comprises applying respective adjustable potential differences to a first lens positioned in front of a first entrance orifice of the first passage and to a second lens positioned in front a second entrance orifice of the second passage, to generate respective electric deflecting fields of desired field strengths across the first entrance orifice and the second entrance orifice.

21. The method of claim 18, wherein controlling the respective flows of the first droplet stream and the second droplet stream further comprises flowing a drying gas in front of one or more of the first passage and the second passage.
